(19) United States
(12) Patent Application Publication
(10) Pub. No.: US 2013/0100418 A1
(43) Pub. Date: Apr. 25, 2013

(54) PROJECTION DISPLAY DEVICE

(71) Applicant: Sanyo Electric Co., Ltd., Moriguchi-city (JP)

(72) Inventor: Tsutomu YOSHIKAWA, Kashihara-city (JP)

(73) Assignee: SANYO ELECTRIC CO., LTD., Moriguchi-city (JP)

(21) Appl. No.: 13/652,171

(22) Filed: Oct. 15, 2012

(30) Foreign Application Priority Data
Oct. 20, 2011 (JP) 2011-231109

(51) Int. Cl. G03B 21/14

(52) U.S. Cl. 353/31

(57) ABSTRACT

A projection display device includes a projection part which enlarges and projects the light flux modulated by an imager onto a projection plane; an opening which is formed in a main body cabinet and through which the light flux outputted from the projection part is passed; and a cover which is mounted in the opening and through which the light flux is transmitted. A light incident surface of the cover has such a curved shape as to set an incident angle of each principal ray transmitted through the cover small, as compared with an arrangement, in which the light incident surface has a flat shape. A light output surface of the cover has such a curved shape as to set an output angle of each principal ray transmitted through the cover small, as compared with an arrangement, in which the light output surface has a flat shape.

This application claims priority under 35 U.S.C. Section 119 of Japanese Patent Application No. 2011-231109 filed Oct. 20, 2011, entitled “PROJECTION DISPLAY DEVICE”. The disclosure of the above application is incorporated herein by reference.

### BACKGROUND OF THE INVENTION

1. Field of the Invention

The present invention relates to a projection display device for modulating a light flux emitted from a light source by an imager, and enlarging and projecting the modulated light flux onto a projection plane.

2. Disclosure of Related Art

Conventionally, in a projection display device (hereinafter, called as a “projector”), a light flux emitted from a light source is modulated by an imager, and the modulated light flux is projected onto a projection plane by a projection optical system.

In such a projector, there has been proposed an arrangement of setting the angle of light to be outputted from a projection optical system wide for shortening the projection distance. For instance, a projection optical system is constituted of a projection lens unit composed of a plurality of lenses, and a reflection mirror for enlarging a light flux outputted from the projection lens unit while reflecting the light flux.

The projection lens unit and the reflection mirror are disposed in a main body cabinet. The main body cabinet is formed with an opening for passing a light flux reflected on the reflection mirror and directed toward a projection plane. A transparent cover is mounted in the opening, and a light flux reflected on the reflection mirror is outputted to the outside of the projector through the cover. The cover is made of a flat plate, with a light flux incident surface and a light flux output surface thereof being formed into a flat shape.

In the case where a cover is mounted in an opening, and the cover is made of a flat plate as described above, light rays constituting a light flux directed toward a projection plane, specifically, most of principal rays in the light rays are entered to the light incident surface of the cover in an oblique direction. As a result, for instance, as shown in FIG. 10A, a part of the light rays entered to the cover repeats reflections on the inner surface of the cover, and the light rays are outputted from the cover in an overlaid manner. This may cause projection of multiple images onto the projection plane. Further, as shown in FIG. 10B, color separation (magnification chromatic aberration) may occur on the light incident surface of the cover due to a difference in refractive index between color components (wavelength components) of the light rays. Furthermore, as shown in FIG. 10C, disposing a cover on the optical paths of the light rays increases the optical path lengths of the light rays. This may displace the position of an image plane to a rear position. In the above arrangement, the optical path length of a principal ray entered to the light incident surface of the cover in an oblique direction is increased, as compared with the optical path length of a principal ray entered to the light incident surface of the cover in a direction substantially perpendicular thereto. Accordingly, the displacement of the image plane to a rear position is increased, and as a result, curvature of image field may occur on the image plane to be formed by the light rays.

Further, peripheral illuminance may be lowered due to a difference in transmittance of light rays resulting from a difference in incident angle/output angle with respect to the cover. Furthermore, an increase in the incident angle/output angle increases a difference in transmittance of light rays at each of the angles with respect to each of the wavelengths. This may cause color variation in a projected image.

### SUMMARY OF THE INVENTION

A projection display device according to a main aspect of the invention includes an imager which modulates alight flux emitted from a light source, a projection part which enlarges and projects the light flux modulated by the imager onto a projection plane, a main body cabinet having the imager and the projection portion, an opening which is formed in the main body cabinet and through which the light flux outputted from the projection part is passed, and a cover which is mounted in the opening and through which the light flux outputted from the projection part is transmitted. In this arrangement, a light incident surface of the cover has such a curved shape as to set an incident angle of each principal ray transmitted through the cover small, as compared with an arrangement, in which the light incident surface has a flat shape. Further, a light output surface of the cover has such a curved shape as to set an output angle of each principal ray transmitted through the cover small, as compared with an arrangement, in which the light output surface has a flat shape.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams showing an external arrangement of a projector embodying the invention.

FIG. 2 is a diagram showing an internal structure of the projector in the embodiment.

FIG. 3 is a diagram schematically showing an arrangement of an imager unit in the embodiment.

FIG. 4 is a diagram schematically showing an arrangement of a projection optical unit in the embodiment.

FIGS. 5A and 5B are diagrams showing an arrangement of a reflection mirror and a cover lens in the embodiment.

FIGS. 6A and 6B are diagrams showing an arrangement of the cover lens in the embodiment.

FIGS. 7A and 7B are diagrams showing an arrangement of a reflection mirror and a cover lens as a modification.

FIGS. 8A and 8B are diagrams showing an arrangement of the cover lens as the modification.

FIG. 9 is a diagram showing an arrangement of a projector as a modification.

FIGS. 10A through 10C are diagrams for describing problems to be solved in the case where a cover is made of a flat plate.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, a projection opening 4 corresponds to an “opening” in the claims. A light source lamp 121 corresponds to a “light source” in the claims. A DMD 134 corresponds to an “imager” in the claims. A projection optical unit 15 corresponds to a “projection part” in the claims. A projection lens unit 200 corresponds to a “projection lens part” in the claims. A reflection mirror 300 corresponds to a “mirror part” in the claims. Cover lenses 500 and 550 correspond to a “cover” in the claims. AR coats 503 and 553 correspond to an “anti-reflection” film in the claims. The description regarding the correspondence between the claims and the embodiment is merely an example, and the claims are not limited by the description of the embodiment.

Further, in the following description, a “light flux” is simply called as “light”, except for a case wherein it is desirable to describe as a “light flux”.

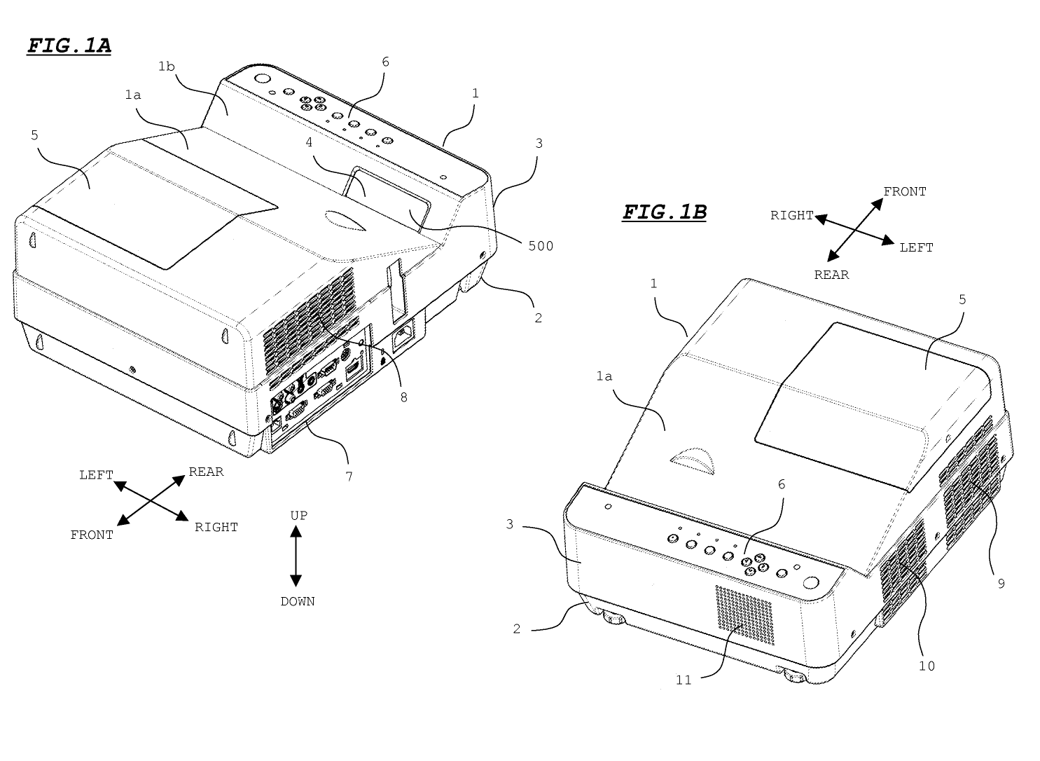

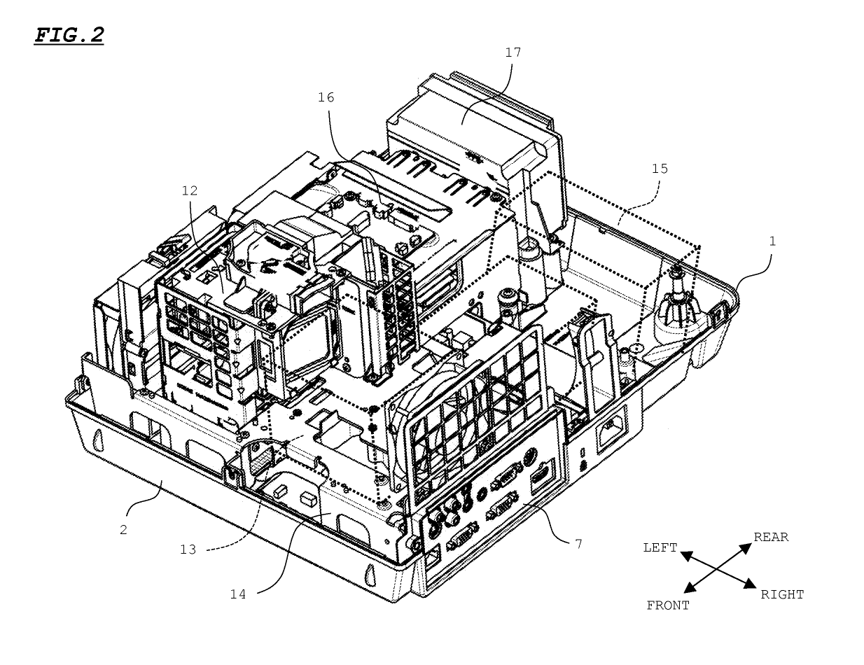

FIG. 1A, FIG. 1B, and FIG. 2 are diagrams showing an external arrangement of a projector. FIG. 1A is a front perspective view of the projector, and FIG. 1B is a rear perspective view of the projector. Further, FIG. 2 is a bottom view of the projector. To simplify the description, in each of the drawings of FIG. 1A, FIG. 1B, and FIG. 2, arrows indicating front and rear directions, left and right directions, and up and down directions are illustrated. In the following, the arrows indicating the respective directions are illustrated in the other drawings, as necessary, in the same manner as described above.

The projector embodying the invention is a so-called short-focus projector. Referring to FIGS. 1A and 1B, the projector is provided with a main body cabinet 1 having a substantially rectangular parallelepiped shape. The main body cabinet 1 is constituted of a lower cabinet 2, and an upper cabinet 3 which is mounted over the lower cabinet 2.

A first slope 1a which is inclined downwardly and rearwardly, and a second slope 1b which is continued from the first slope 1a and is inclined upwardly and rearwardly are formed on the top surface of the main body cabinet 1. The second slope 1b faces obliquely upward and forward, and a projection opening 4 is formed in the second slope 1b. Image light outputted obliquely upward and forward through the projection opening 4 is enlarged and projected onto a screen disposed at a front position of the projector. A cover lens 500 is mounted in the projection opening 4. The arrangement of the cover lens 500 will be described later.

Further, a lamp cover 5 is mounted on the top surface of the main body cabinet 1. The lamp cover 5 covers a lamp opening for use in replacement of a lamp unit. Further, an operation key portion 6 constituted of a plurality of operation keys is formed on the top surface of the main body cabinet 1.

A terminal portion 7 is formed on the right surface of the main body cabinet 1. Various terminals such as an AV terminal are disposed in the terminal portion 7. An AV (Audio Visual) signal such as an image signal or an audio signal is inputted to and outputted from the projector through the AV terminal. Further, an air inlet 8 is formed in the right surface of the main body cabinet 1 at a position above the terminal portion 7. External air is drawn into the main body cabinet 1 through the air inlet 8.

Air outlets 9 and 10 are formed in a front portion and in an intermediate portion on the left surface of the main body cabinet 1. The air inside the main body cabinet 1 is drawn out to the outside of the projector through the air outlets 9 and 10. Further, a sound output port 11 is formed in the rear surface of the main body cabinet 1.

FIG. 2 is a diagram showing an internal structure of the projector. FIG. 2 is a front perspective view of the projector showing a state that the upper cabinet 3 is removed. To simplify the description, in FIG. 2, an imager unit 13 and a projection optical unit 15 are illustrated by the dotted lines.

Referring to FIG. 2, a lamp unit 12, and the imager unit 13 for modulating light emitted from the lamp unit 12 and generating image light are disposed at a front portion of the lower cabinet 2.

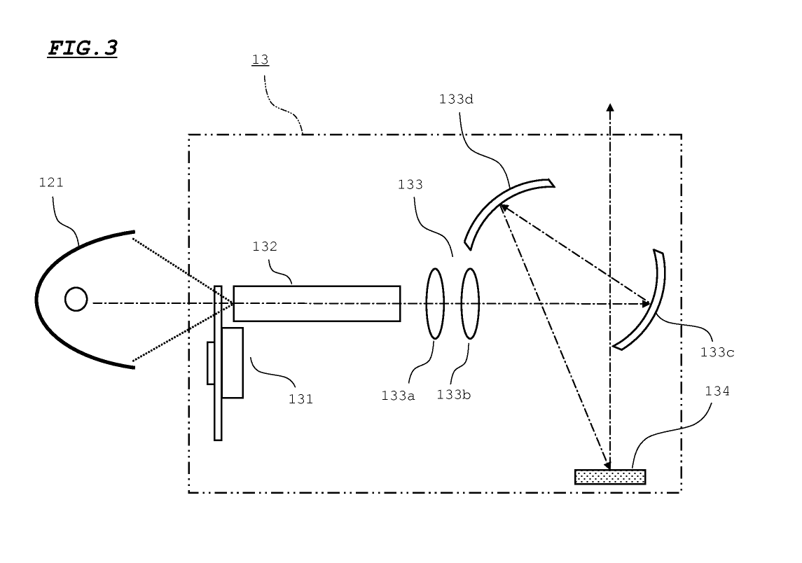

The lamp unit 12 is constituted of a light source lamp 121 (see FIG. 3), and a lamp holder for holding the light source lamp 121. The lamp unit 12 is held on the lower cabinet 2 in such a manner as to be detachable from above.

FIG. 3 is a diagram schematically showing an arrangement of the imager unit 13.

The imager unit 13 includes a color wheel 131, a light tunnel 132, a relay optical system 133, and a DMD (Digital Micromirror Device) 134.

The color wheel 131 separates white light from the light source lamp 121 into light of each colors such as red, green, and blue in a time-sharing manner. The light tunnel 132 has a hollow inner portion, and an inner surface thereof is formed into a mirror surface. Light entered in the light tunnel 132 repeats reflections while passing through the light tunnel 132, whereby the intensity distribution of light is made uniform.

The relay optical system 133 is constituted of two relay lenses 133a and 133b, and two concave mirrors 133c and 133d. The relay optical system 133 guides the light outputted from the light tunnel 132 to the DMD 134. The DMD 134 modulates the light (light of the each colors such as red, green, and blue) guided by the relay optical system 133, based on an image signal.

Referring back to FIG. 2, the imager unit 13 is disposed above a control circuit unit 14. A control circuit for controlling various driving components such as the light source lamp 121 and the DMD 134 is provided in the control circuit unit 14.

The projection optical unit 15 is disposed at a rear position of the imager unit 13. A light flux (hereinafter, called as “image light”) modulated by the DMD 134 is entered to the projection optical unit 15. The projection optical unit 15 enlarges the entered image light, and projects the enlarged image light onto a projection plane such as a screen.

A power source unit 16 and a speaker unit 17 are disposed on the left of the projection optical unit 15. The power source unit 16 is provided with a power source circuit, and supplies electric power to each of the electrical components of the projector. The speaker unit 17 outputs a sound corresponding to an image when the image is projected, and the outputted sound is released to the outside through the sound output port 11.

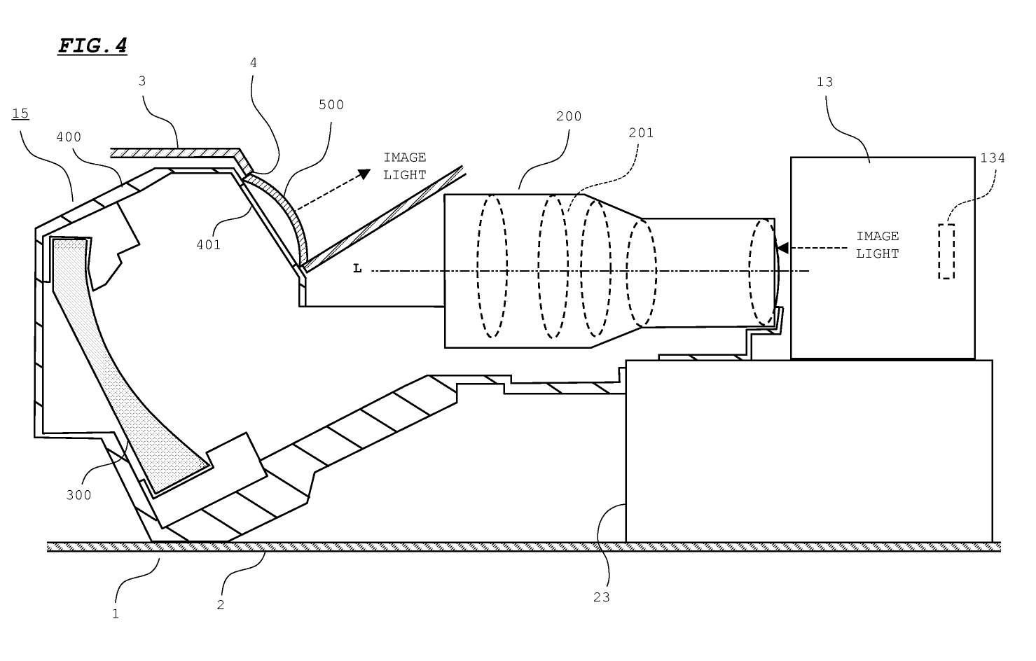

FIG. 4 is a diagram schematically showing an arrangement of the projection optical unit 15. In FIG. 4, the imager unit 13 and the control circuit unit 14 are schematically illustrated in addition to the projection optical unit 15.

The projection optical unit 15 is constituted of a projection lens unit 200, a reflection mirror 300, and a housing 400.

The projection lens unit 200 has a plurality of lenses 201. The reflection mirror 300 is a curved surface mirror. The housing 400 houses therein the projection lens unit 200 and the reflection mirror 300. An output port 401 for outputting image light is formed in the housing 400.

The output port 401 of the housing 400 is covered by the cover lens 500. When the upper cabinet 3 is mounted on the lower cabinet 2, the cover lens 500 is fitted in the projection opening 4 from the inside.

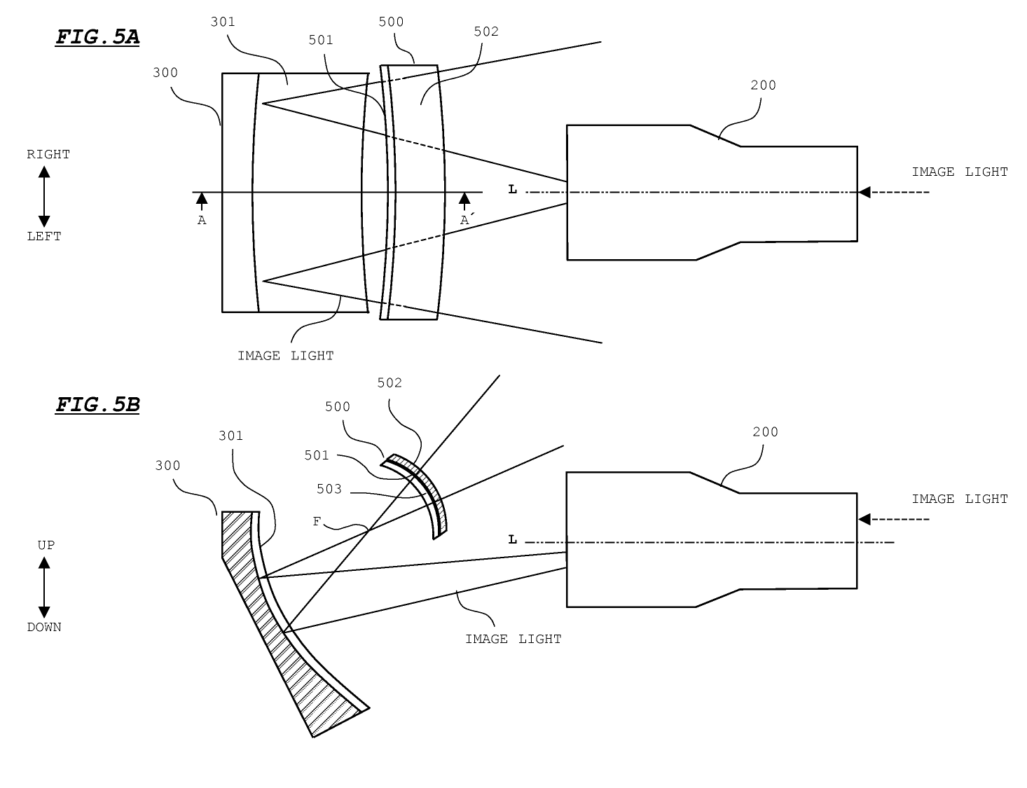

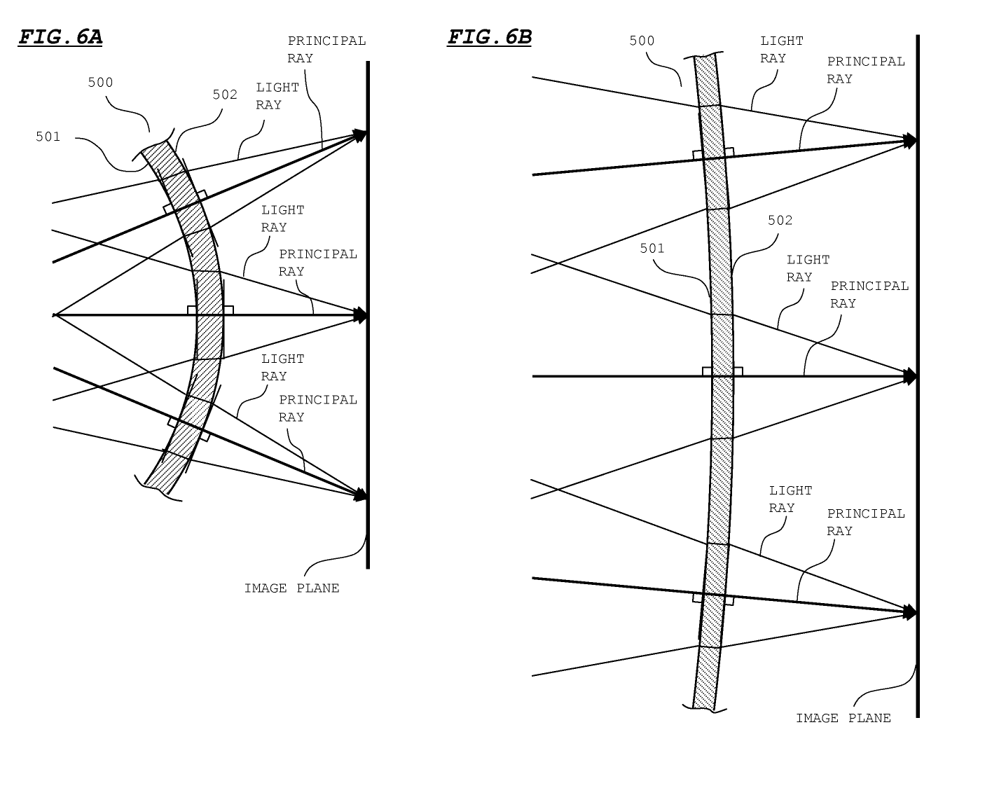

FIG. 5A, FIG. 5B, FIG. 6A, and FIG. 6B are diagrams for describing an arrangement of the reflection mirror 300 and the cover lens 500.

FIG. 5A is a top schematic view of the projection optical unit 15, and FIG. 5B is a side schematic view of the projection optical unit 15. To simplify the description, in FIGS. 5A and 5B, illustration of the housing 400 is omitted. Further, FIG. 5B also shows a cross-sectional view of the reflection mirror 300 and the cover lens 500 taken along the line A-A′ in FIG. 5A.

FIGS. 6A and 6B are respectively a vertical sectional view and a horizontal sectional view of the cover lens 500, schematically showing the shape of a light incident surface 501 and a light output surface 502 of the cover lens 500.

As shown in FIGS. 5A and 5B, image light outputted from the imager unit 13 is entered to the projection lens unit 200 at a position shifted in a direction toward the top surface of the main body cabinet 1 with respect to the optical axis L of the projection lens unit 200. The entered image light undergoes a lens action by the projection lens unit 200, and is outputted from the projection lens unit 200 at a position shifted in a direction toward the bottom surface of the main body cabinet 1 with respect to the optical axis L.

The reflection mirror 300 is disposed at such a position that the center thereof is shifted in a direction toward the bottom surface of the main body cabinet 1 with respect to the optical axis L of the projection lens unit 200. Image light outputted from the projection lens unit 200 is entered to the reflection mirror 300 while diffusing in up and down directions and in left and right directions.

The reflection mirror 300 has a reflection surface 301 which is formed into a concave curved surface. The angle of image light is set wide by reflection on the reflection surface 301. Then, the image light is transmitted through the cover lens 500, and is directed toward the projection plane (screen surface). With this arrangement, image light is temporarily converged and then is directed toward the projection plane while diffusing again in up and down directions by the reflection on the reflection mirror 300. In this embodiment, as shown in FIG. 5B, the positional relationship between the reflection mirror 300 and the cover lens 500 is defined in such a manner that the position F where image light is maximally converged is located at a position closer to the reflection mirror 300 than the cover lens 500.

The cover lens 500 has a rectangular shape, with a transverse length thereof being substantially long when viewed from a front side. The cover lens 500 is made of a transparent resin material (such as cycloolefin polymer or polycarbonate) or a glass material capable of transmitting image light. Further, the cover lens 500 is formed to have a substantially constant thickness.

As shown in FIGS. 5A and 5B, image light is entered to the cover lens 500 while diffusing in up and down directions and in left and right directions. The light incident surface 501 of the cover lens 500 has such a curved shape as to be concave toward the propagating direction of image light in up and down directions and in left and right directions to follow an output state of image light as described above. Further, the light output surface 502 of the cover lens 500 has such a curved shape as to be convex toward the propagating direction of image light in up and down directions and in left and right directions. Further, the light incident surface 501 and the light output surface 502 are moderately curved in left and right directions, as compared with up and down directions.

An AR coat (Anti Reflection Coating) 503 as an anti-reflection film is applied to the light incident surface 501 of the cover lens 500. The AR coat 503 reduces reflection on the light incident surface 501 by optical interference.

The details of the surface configuration of the light incident surface 501 and the light output surface 502 of the cover lens 500 are described referring to FIGS. 6A and 6B.

As shown in FIGS. 6A and 6B, the light incident surface 501 of the cover lens 500 has such a curved shape that the direction vector of a principal ray among the light rays constituting image light substantially perpendicularly intersects the light incident surface 501, in other words, the incident angle of each of the principal rays to be entered to the light incident surface 501 is substantially set to zero degree (e.g. 0±5 degrees). Further, the light output surface 502 of the cover lens 500 has such a curved shape that the direction vector of each of the principal rays substantially perpendicularly intersects the light output surface 502, in other words, the output angle of each of the principal rays to be outputted from the light output surface 502 is substantially set to zero degree (e.g. 0±5 degrees).

The output direction of each of the light rays constituting image light is determined by design of the projection lens unit 200 and the reflection mirror 300. Therefore, it is possible to form the light incident surface 501 and the light output surface 502 of the cover lens 500 into various shapes such as a spherical shape, an aspherical shape, a toric shape, a toroidal shape, and a free curved shape, so that the incident angle and the output angle are substantially set to zero degree to follow an output state of each of the light rays.

As described above, in this embodiment, the light incident surface 501 of the cover lens 500 has such a curved shape that the incident angle of each of the principal rays is substantially set to zero degree, and the light output surface 502 of the cover lens 500 has such a curved shape that the output angle of each of the principal rays is substantially set to zero degree, with respect to image light to be transmitted through the cover lens 500 while diffusing in up and down directions and in left and right directions.

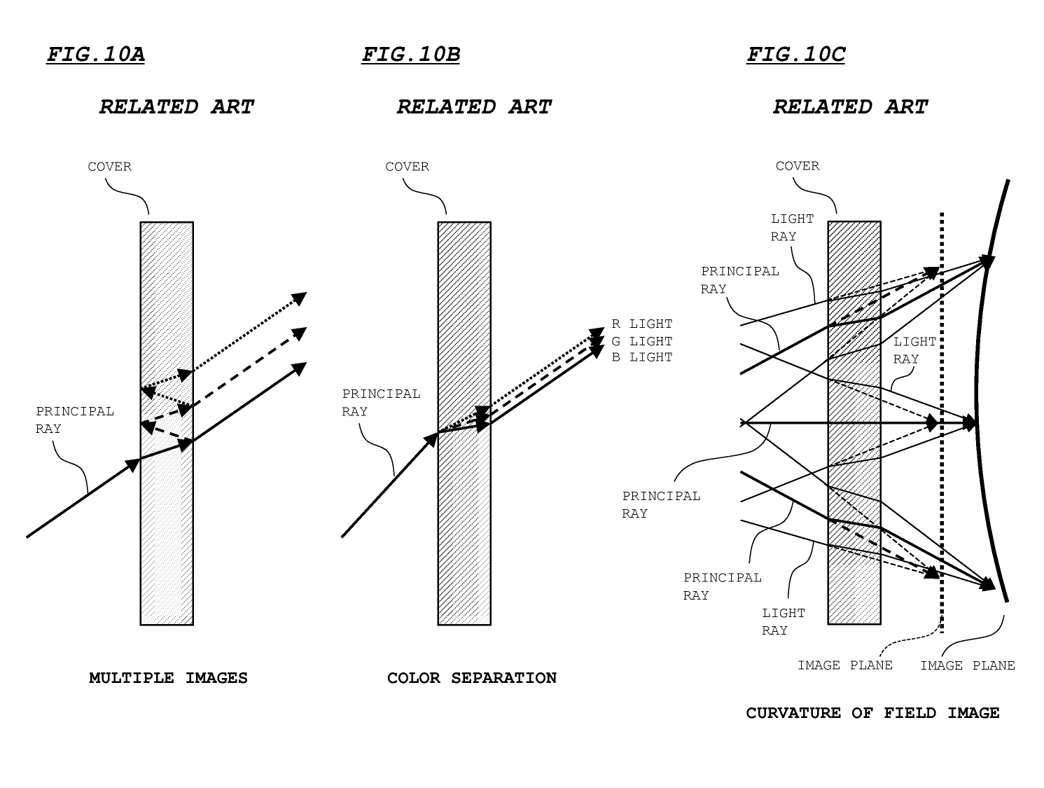

With the above arrangement, as shown in FIGS. 5A and 5B, increases in the optical path length of light rays due to provision of the cover lens 500 are substantially set equal to each other. Accordingly, unlike the arrangement (see FIG. 10C), in which the cover lens 500 has a flat plate shape, it is possible to suppress forward or rearward displacement of an image forming position of each of the light rays. Thus, it is possible to suppress curvature of field image on an image plane to be formed by the light rays.

Further, unlike the arrangement (see FIG. 10A), in which the cover lens 500 has a flat plate shape, it is possible to suppress repeated reflections of a part of the light rays entered to the cover lens 500 on the inner surface of the cover lens 500. Thus, it is possible to suppress generation of multiple images on a projection plane.

Further, unlike the arrangement (see FIG. 10B), in which the cover lens 500 has a flat plate shape, it is possible to suppress color separation (magnification chromatic aberration) on the light incident surface 501 of the cover lens 500.

Further, since the AR coat 503 is applied to the light incident surface 501 of the cover lens 500, it is possible to suppress reflection of a light flux on the light incident surface of the cover lens 500. In this example, in the case where the principal rays are entered to the surface of the AR coat 503 in an oblique direction, a difference in anti-reflection effect may occur due to a difference in color components (wavelength components) of the light rays. If such a difference occurs, the amount of light to be transmitted through the cover lens 500 may differ depending on the light rays of the respective color components, and color variation may occur in a projected image. In this aspect, the above arrangement of the embodiment is advantageous in setting the incident angle of each of the principal rays small with respect to the surface of the AR coat 503, in other words, substantially setting the incident angle to zero degree. Accordingly, the embodiment is advantageous in suppressing a difference in anti-reflection effect, and in suppressing color variation in a projected image.

Further, in this embodiment, as compared with an arrangement in which a cover lens 500 has a flat plate shape, the incident angle/output angle of each of the light rays with respect to the cover lens 500 is restricted to a narrow range. This reduces a difference in transmittance of light rays, and suppresses lowering of peripheral illuminance. Further, since the change in transmittance of light rays with respect to each of the wavelengths is reduced, it is possible to suppress color variation in a projected image.

In the embodiment, it is possible to increase the angle of a light flux outputted from the DMD 134, and shorten the projection distance by the projection lens unit 200 and the reflection mirror 300. Thus, the embodiment makes it easy to allow incidence of each of the principal rays onto the cover lens 500 in an oblique direction (with a large incident angle), in the case where the angle of a light flux is set wide by the projection optical unit 15.

In the embodiment, the incident angle and the output angle of each of the principal rays can be reduced, specifically, can be substantially set to zero degree. Accordingly, it is possible to suppress generation of multiple images, color separation, curvature of field image and color variation, and to suppress lowering of peripheral illuminance, while setting the angle of a light flux outputted from the DMD 134 wide.

Thus, the embodiment is advantageous in suppressing image quality degradation resulting from provision of the cover lens 500, in the case where the cover lens 500 is mounted in the projection opening 4.

### Modification

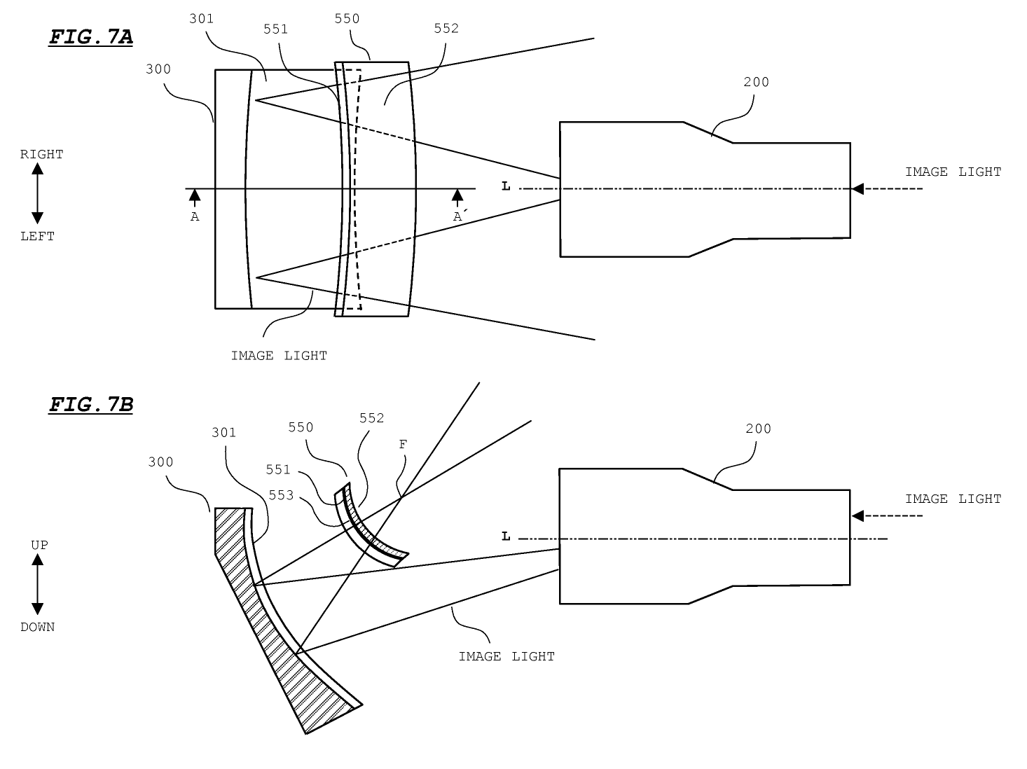

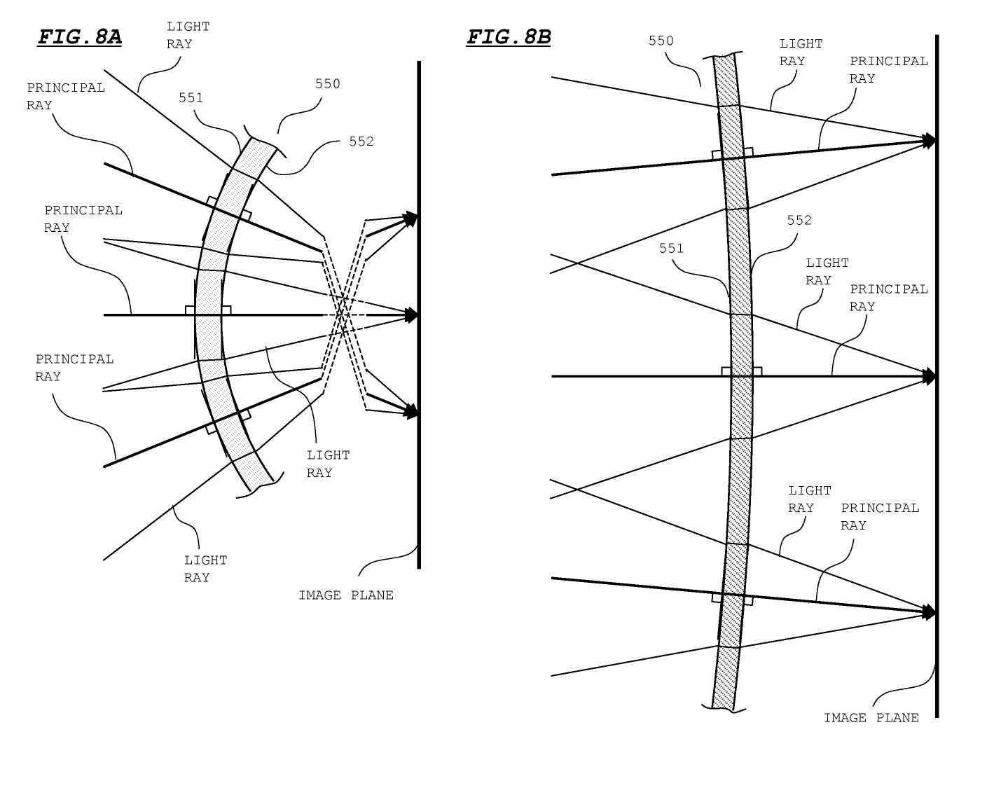

FIG. 7A, FIG. 7B, FIG. 8A and FIG. 8B are diagrams for describing an arrangement of a cover lens 550 as a modification.

FIG. 7A is a top schematic view of a projection optical unit 15, and FIG. 7B is a side schematic view of the projection optical unit 15. To simplify the description, in FIGS. 7A and 7B, illustration of a housing 400 is omitted. Further, FIG. 7B also shows a cross-sectional view of a reflection mirror 300 and the cover lens 550 taken along the line A-A′ in FIG. 7A.

FIGS. 8A and 8B are respectively a vertical sectional view and a horizontal sectional view of the cover lens 550, schematically showing the shape of a light incident surface 551 and a light output surface 552 of the cover lens 550. In FIG. 8A, illustration of a part of optical paths of light rays is omitted between the cover lens 550 and the image plane, and the omitted part is indicated by the broken lines.

In the modification, as shown in FIG. 7B, the positional relationship between the reflection mirror 300 and the cover lens 550 is defined in such a manner that the position F where image light is maximally converged is located at a position closer to the projection plane than the cover lens 550. Accordingly, whereas image light is entered to the cover lens 550 while diffusing in left and right directions as shown in FIG. 7A, image light is entered to the cover lens 550 while converging in up and down directions as shown in FIG. 7B. The light incident surface 551 of the cover lens 550 has such a curved shape that the light incident surface 551 is concave toward the propagating direction of image light in left and right directions, and is convex toward the direction opposite to the propagating direction of image light in up and down directions to follow an output state of image light as described above. Further, the light output surface 552 of the cover lens 550 has such a curved shape that the light output surface 552 is convex toward the propagating direction of image light in left and right directions, and is concave toward the direction opposite to the propagating direction of image light in up and down directions. The light incident surface 551 and the light output surface 552 are moderately curved in left and right directions, as compared with up and down directions.

The details of the surface configuration of the light incident surface 551 and the light output surface 552 of the cover lens 550 are described. As shown in FIGS. 8A and 8B, the light incident surface 551 has such a curved shape that the direction vector of a principal ray among the light rays constituting image light substantially perpendicularly intersects the light incident surface 551, in other words, the incident angle of each of the principal rays to be entered to the light incident surface 551 is substantially set to zero degree (e.g. 0±5 degrees). Further, the light output surface 552 has such a curved shape that the direction vector of each of the principal rays substantially perpendicularly intersects the light output surface 552, in other words, the output angle of each of the principal rays to be outputted from the light output surface 552 is substantially set to zero degree (e.g. 0±5 degrees).

As shown in FIG. 7B, an AR coat 553 is applied to the light incident surface 551 of the cover lens 550 in the same manner as in the embodiment.

As described above, in the modification, the light incident surface 551 of the cover lens 550 has such a curved shape that the incident angle of each of the principal rays is substantially set to zero degree, and the light output surface 552 of the cover lens 550 has such a curved shape that the output angle of each of the principal rays is substantially set to zero degree, with respect to image light to be transmitted through the cover lens 550 while diffusing in left and right directions and converging in up and down directions. With this arrangement, similarly to the embodiment, it is possible to suppress curvature of field image, multiple images, color separation, and color variation, and to suppress lowering of peripheral illuminance. Therefore, it is possible to suppress image quality degradation resulting from provision of the cover lens 550.

### Others

The embodiment of the invention has been described as above. The invention is not limited to the foregoing embodiment, and the embodiment of the invention may be modified in various ways other than the above, as far as such modifications do not depart from the scope of the claims of the invention hereinafter defined.

For instance, the light incident surface 501 and the light output surface 502 of the cover lens 500 may not necessarily have such a curved shape as to substantially set the incident angle and the output angle of each of the principal rays to be transmitted through the cover lens 500 to zero degree, respectively. Specifically, the light incident surface 501 and the light output surface 502 may have such a curved shape that at least the incident angle and the output angle of each of the principal rays are reduced, as compared with an arrangement, in which a cover lens 500 has a flat plate shape. However, forming the light incident surface 501 and the light output surface 502 into such a curved shape as to substantially set the incident angle and the output angle of each of the principal rays to zero degree as described in the embodiment is further advantageous in enhancing the effect of suppressing image quality degradation resulting from provision of the cover lens 500.

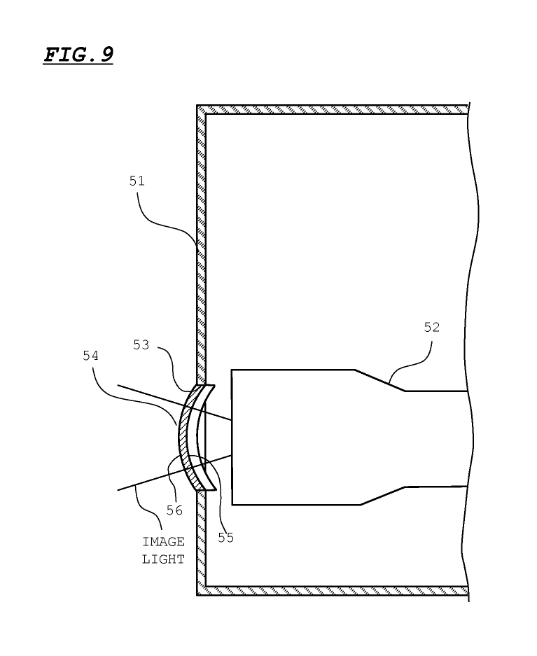

Further, in the embodiment, a short-focus projector incorporated with a projection optical system including the projection lens unit 200 and the reflection mirror 300 has been described as an example of the projector. Alternatively, the invention may be applied to a projector incorporated with a projection optical system without a reflection mirror. For instance, as shown in FIG. 9, a projection lens unit 52 is disposed in a main body cabinet 51 in such a manner that a leading end of the projection lens unit 52 is not projected from a front surface of the main body cabinet 51. A projection opening 53 is formed in the front surface of the main body cabinet 51 for passing image light outputted from the projection lens unit 52. A cover lens 54 is mounted in the projection opening 53. A light incident surface 55 and a light output surface 56 of the cover lens 54 respectively have such a curved shape as to substantially set the incident angle and the output angle of each of the principal rays to zero degree in the same manner as in the embodiment.

Further, in the embodiment, the DMD 134 is used as an imager constituting the imager unit 13. Alternatively, a liquid crystal panel may be used.

Furthermore, in the embodiment, the lamp unit 12 having the light source lamp 121 is used. Alternatively, a light source other than a lamp light source, such as a laser light source or an LED light source may be used.

The embodiment of the invention may be changed or modified in various ways as necessary, as far as such changes and modifications do not depart from the scope of the claims of the invention hereinafter defined.

What is claimed is:

1. A projection display device, comprising:
an imager which modulates a light flux emitted from a light source;
a projection part which enlarges and projects the light flux modulated by the imager onto a projection plane;
a main body cabinet having the imager and the projection part;
an opening which is formed in the main body cabinet and through which the light flux outputted from the projection part is passed; and
a cover which is mounted in the opening and through which the light flux outputted from the projection part is transmitted, wherein
a light incident surface of the cover has such a curved shape as to set an incident angle of each principal ray transmitted through the cover small, as compared with an arrangement, in which the light incident surface has a flat shape, and
a light output surface of the cover has such a curved shape as to set an output angle of each principal ray transmitted through the cover small, as compared with an arrangement, in which the light output surface has a flat shape.

2. The projection display device according to claim 1, wherein
the light incident surface of the cover has such a curved shape as to substantially set the incident angle of the each principal ray to zero degree, and
the light output surface of the cover has such a curved shape as to substantially set the output angle of the each principal ray to zero degree.

3. The projection display device according to claim 1, wherein
an anti-reflection film is formed on the light incident surface of the cover.

4. The projection display device according to claim 1, wherein
the projection part includes a projection lens part which allows incidence of the light flux outputted from the imager, and a mirror part which reflects the light flux transmitted through the projection lens portion and directs the reflected light flux toward the projection plane, the mirror part having a reflection surface formed into a curved shape.
